(19) United States
(12) Patent Application Publication
(10) Pub. No.: US 2005/0050219 A1
(43) Pub. Date: Mar. 3, 2005

(54) Method for data streaming in ad-hoc wireless local area network

(75) Inventors: Hyong-uk Choi, Seoul (KR); Hee-yong Park, Suwon-si (KR); Seong-hee Lee, Seoul (KR); Suk-jin Yun, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/929,555

(22) Filed: Aug. 31, 2004

(30) Foreign Application Priority Data
Sep. 3, 2003 (KR) 2003-0061510

(51) Int. Cl. G06F 15/16

(52) U.S. Cl. 709/231

(57) ABSTRACT

A method for data streaming in an ad-hoc wireless local area network (LAN). The method for data streaming includes receiving at least one streaming request frame that requests transmission of streaming data to at least one station, and transmitting frames containing the streaming data to at least one station with Short InterFrame Space (SIFS) interval. Streaming data is reliably transmitted in an ad-hoc wireless LAN without greatly changing existing wireless LAN standards.

This application is based on and claims priority from Korean Patent Application No. 10-2003-0061510 filed on Sep. 3, 2003 in the Korean Intellectual Property Office, the disclosure of which is incorporated herein in its entirety by reference.

### BACKGROUND OF THE INVENTION

1. Field of the Invention

The present invention relates to a method for data streaming in an ad-hoc wireless local area network (LAN).

2. Description of the Related Art

With the recent development of multimedia technology and an increased demand for multimedia content, demand for transfer of streaming data containing multimedia content has increased. Conventionally, data streaming services have usually been provided through wired Internet. However, with the development of wireless LAN technology and the increasing spread of wireless LAN products, demand for data streaming services through the wireless LAN has increased. Meanwhile, data transfer between stations is competitively performed in an ad-hoc wireless LAN. Accordingly, for data streaming in the ad-hoc wireless LAN, a frame containing streaming data needs to be transmitted competitively, but frame transmission is not always guaranteed. Only when streaming data is transmitted in real time, the purpose of the streaming data can be achieved. However, under a competitive channel environment, real-time data transmission cannot be guaranteed. In this situation, conventional streaming data transmission according to the IEEE 802.11 specification is possible only when only two stations, i.e., a transmitting station and a receiving station, are present. In other words, it is difficult to guarantee real-time data transmission/reception when other stations are present in addition to the transmitting station and the receiving station. Accordingly, a method for reliably and wirelessly transmitting and receiving streaming data such as multimedia content in real time in an ad-hoc wireless LAN is desired. In addition, a method allowing a request to stop streaming and transmission of new streaming data is desired.

### SUMMARY OF THE INVENTION

The present invention provides a method for transmitting and receiving streaming data in an ad-hoc wireless local area network (LAN).

The present invention also provides a method of transmitting control information such as a request for changing streaming to a transmitting station during transmission/reception of streaming data.

According to an exemplary embodiment of the present invention, there is provided a method for data streaming in an ad-hoc wireless LAN. The method comprises receiving a streaming request frame that requests to transmit a first streaming data to a predetermined station, and transmitting frames containing the first streaming data to the predetermined station with a Short InterFrame Space (SIFS) interval.

The streaming request frame is preferably transmitted by the predetermined station. When an acknowledgement containing the predetermined control information is received from the station, the method may further comprise performing an operation according to predetermined control information. The predetermined control information contained in the received acknowledgement is preferably a streaming request that requests transmission of second streaming data, and, preferably, the operation, according to the predetermined control information, includes transmitting frames containing the second streaming data to the station with Short InterFrame Space (SIFS) interval.

According to another exemplary embodiment of the present invention, there is provided a method for data streaming in an ad-hoc wireless LAN. The method comprises receiving a first streaming request frame that requests to transmit first streaming data to a first station, receiving a second streaming request frame that requests to transmit second streaming data to a second station, and transmitting frames containing the first streaming data to the first station and frames containing the second streaming data to the second station with SIFS interval according to a predetermined sequence.

The first streaming request frame may be transmitted by the first station and the second streaming request frame may be transmitted by the second station.

The method may comprise performing an operation according to predetermined control information when an acknowledgement containing the predetermined control information is received from the first or second station. The predetermined control information contained in the received acknowledgement is a streaming request that requests transmission of third streaming data, and frames containing the third streaming data are transmitted to the transmitting station of the acknowledgement frame containing the control information.

According to still another exemplary embodiment of the present invention, there is provided a method for data streaming in an ad-hoc wireless local area network. The method comprises generating a streaming request frame requesting transmission of first streaming data and transmitting the streaming request frame to a streaming service station, and receiving frames coritaining the first streaming data from the streaming service station with Short InterFrame Space (SIFS) interval.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic diagram of a data streaming environment according to an exemplary embodiment of the present invention;

FIG. 2 is a schematic diagram of a data streaming environment according to another exemplary embodiment of the present invention;

FIG. 3 is a schematic diagram of data streaming environment according to still another exemplary embodiment of the present invention;

FIG. 4 illustrates transmission of streaming data in the environment shown in FIG. 2;

FIG. 5 illustrates streaming between a streaming service station and a receiving station according to an exemplary embodiment of the present invention;

FIG. 6 illustrates transmission/reception of control information between the streaming service station and the receiving station according to an exemplary embodiment of the present invention;

FIG. 7 is a flowchart of operations of the receiving station in an application layer, in an exemplary embodiment of the present invention;

FIG. 8 is a flowchart of operations of the receiving station in a medium access control (MAC) layer, in an exemplary embodiment of the present invention;

FIG. 9 is a flowchart of operations of the streaming service station in the MAC layer, in an exemplary embodiment of the present invention;

FIG. 10 is a flowchart of operations of the streaming service station in the application layer, in an exemplary embodiment of the present invention;

FIG. 11 illustrates an acknowledgement frame containing control information according to an exemplary embodiment of the present invention;

FIG. 12 illustrates the configuration of a channel transmitting streaming data ideally;

FIG. 13 illustrates the configuration of a channel where a target beacon transmission time (TBTF) is encountered during streaming data transmission;

FIG. 14 illustrates the configuration of a channel where beacon collision occurs at a TBTT during normal data transmission; and

FIG. 15 illustrates the configuration of a channel where collision with a beacon transmitted by a station having a random delay of 0 occurs when a start of streaming data transmission coincides with a TBTT.

### DETAILED DESCRIPTION OF THE INVENTION

Hereinafter, exemplary embodiments of the present invention will be described in detail with reference to the attached drawings.

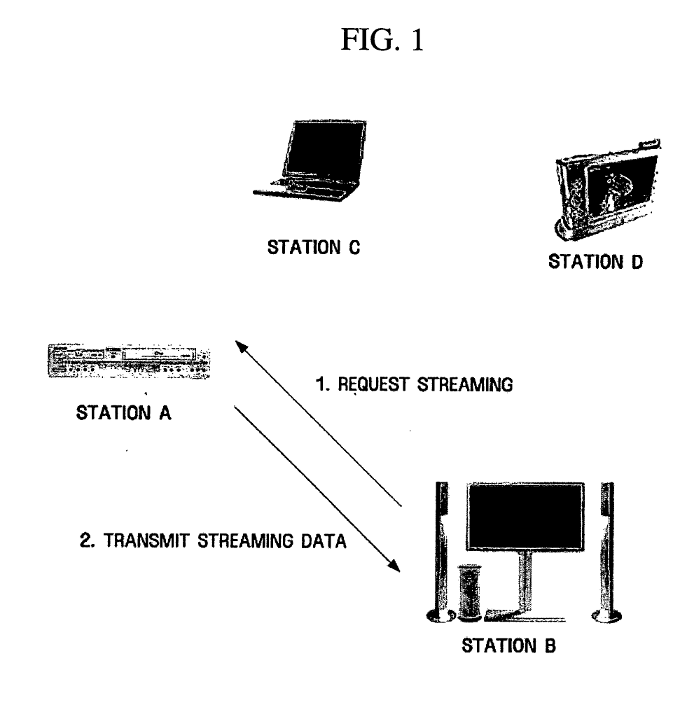

FIGS. 1 through 3 are schematic diagrams of a data streaming environment according to exemplary embodiments of the present invention.

Conventionally, it is difficult to transmit streaming data such as multimedia data in real time in a competitive environment. FIGS. 1 through 3 illustrate environments in which streaming data transmission is possible according to embodiments of the present invention. FIG. 1 illustrates streaming data transmission between two stations. Station B wanting to receive streaming data from station A competitively transmits a streaming request frame to the station A. Upon receiving the streaming request frame, the station A transmits streaming data to the station B. When the streaming data is transmitted, frames are transmitted with an interval of Short InterFrame Space (SIFS). Where the station A transmits frames to the station B with SIFS interval, station C and station D are always beaten in the competition and thus cannot transmit frames.

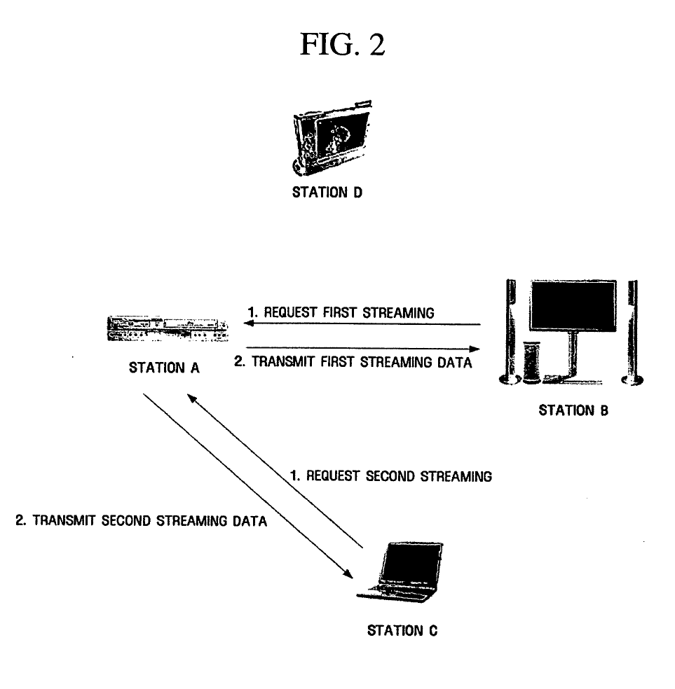

FIG. 2 illustrates an environment where a single station transmits streaming data to two stations. The station B and the station C competitively transmit first and second streaming request frames, respectively, to the station A. According to information contained in the first and second streaming request frames, the station A transmits first streaming data to the station B and second streaming data to the station C. Frames of the first and second streaming data are transmitted with a SIFS interval so that other stations cannot transmit frames.

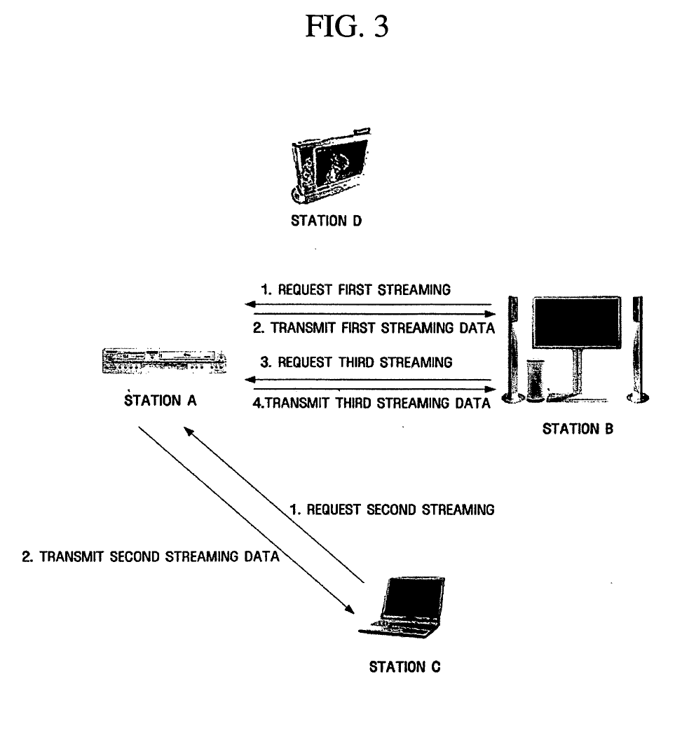

FIG. 3 illustrates another environment where a single station transmits streaming data to two stations. Like the environment shown in FIG. 2, the station B and the station C transmit first and second streaming request frames, respectively, to the station A and receive first streaming data and second streaming data, respectively, from the station A. While receiving the first streaming data, the station B transmits a third streaming request frame to the station A in order to receive new streaming data from the station A. Then, the station A transmits third streaming data to the station B. The second streaming request frame requesting new streaming data during reception of the first streaming data may be competitively transmitted after receiving frames with SIFS interval. However, it may be preferable to transmit information requesting new streaming data over an acknowledgement frame transmitted in response to reception of the first streaming data. Frames of the first, second, and third streaming data are transmitted with SIFS interval so that other stations cannot transmit frames.

In the environments shown in FIGS. 1 through 3, it may be preferable that a streaming request frame is formed by embedding a parameter, that can be recognized by an application of the station A that transmits streaming data, into channel information capable of containing data in a normal data frame. However, forming a streaming request frame using a normal data frame is just an example, and the spirit of the present invention is not restricted thereto. The station A receiving a plurality of streaming request frames transmits streaming data to a plurality of stations in an appropriate sequence.

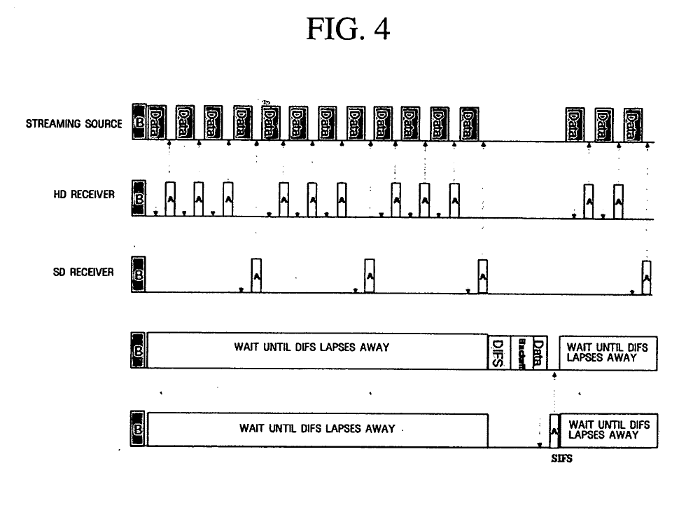

FIG. 4 illustrates transmission of streaming data in the environment shown in FIG. 2.

In FIG. 4, “B” denotes a beacon frame, “Data” denotes a data frame, and “A” denotes an acknowledgement frame. “DIFS” stands for Distributed InterFrame Space that is interframe space distinguishing atomic exchanges (of a frame and its acknowledgement frame) in a service based on competition. “Backoff” denotes a period of time defined to make stations transmit frames after a random period of time since DIFS has lapsed so that collision that occurs when the stations simultaneously transmit the frames after the DIFS can be prevented.

FIG. 4 illustrates a basic service set where five stations are present: a streaming source, a high definition (HD) receiver receiving streaming data, a standard definition (SD) receiver receiving streaming data, and two normal stations. The HD receiver and the SD receiver respectively transmit streaming request frames to the streaming source. Then, the streaming source transmits streaming data to the HD receiver and the SD receiver. The HD receiver needs to receive a large amount of data in real time while the SD receiver needs a relatively less amount of data than the HD receiver. The streaming source transmits frames containing streaming data in levels requested by the streaming request frames to the HD receiver and the SD receiver in an appropriate sequence., A gap between a frame containing streaming data and its acknowledgement frame is set to SIFS, which is shorter than DIFS, so that the other normal stations cannot transmit data. After the transmission of the streaming data is completed, the normal stations competitively transmit data after DIFS and backoff time.

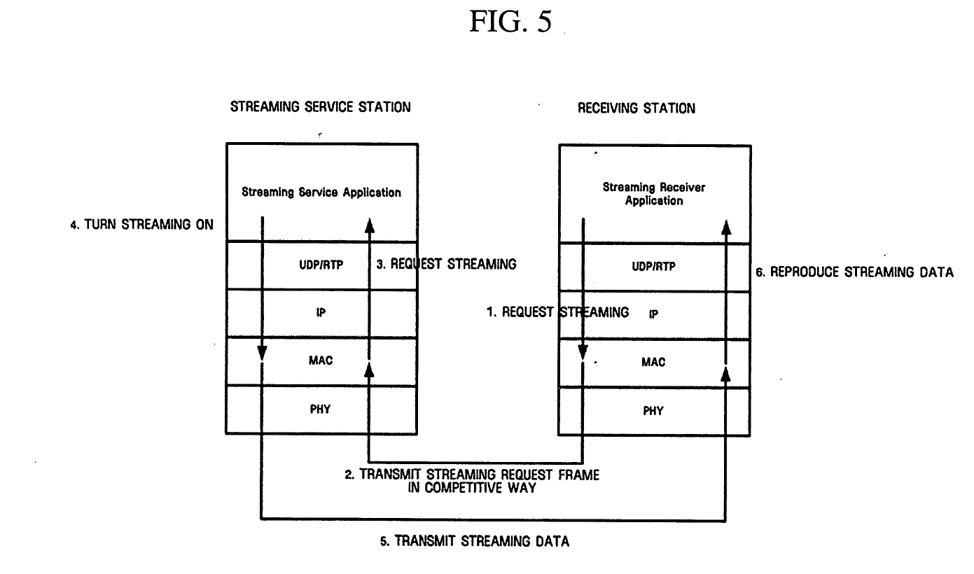

FIG. 5 illustrates streaming between a streaming service station and a receiving station according to an exemplary embodiment of the present invention.

If a streaming receiver application layer in the receiving station transmits a streaming request demanding transmission of desired streaming data to a medium access control (MAC) layer, the MAC layer generates a streaming request frame with an appropriate header and tail and transmits the streaming request frame to the streaming service station in a competitive way. A MAC layer in the streaming service station transmit the streaming request frame to a streaming service application layer after removing the header and the tail from the streaming request frame. The streaming service application layer requests the MAC layer to be converted into a streaming-on state in response to the streaming request, and thus, the MAC layer changes into the streaming-on state. Then, the MAC layer transmits streaming data received from the streaming service application to the receiving station. Then, the receiving station receives and reproduces the streaming data. Preferably, the streaming request frame is a normal data frame and contains a parameter enabling the streaming service application to recognize the request to transmit streaming data in channel information.

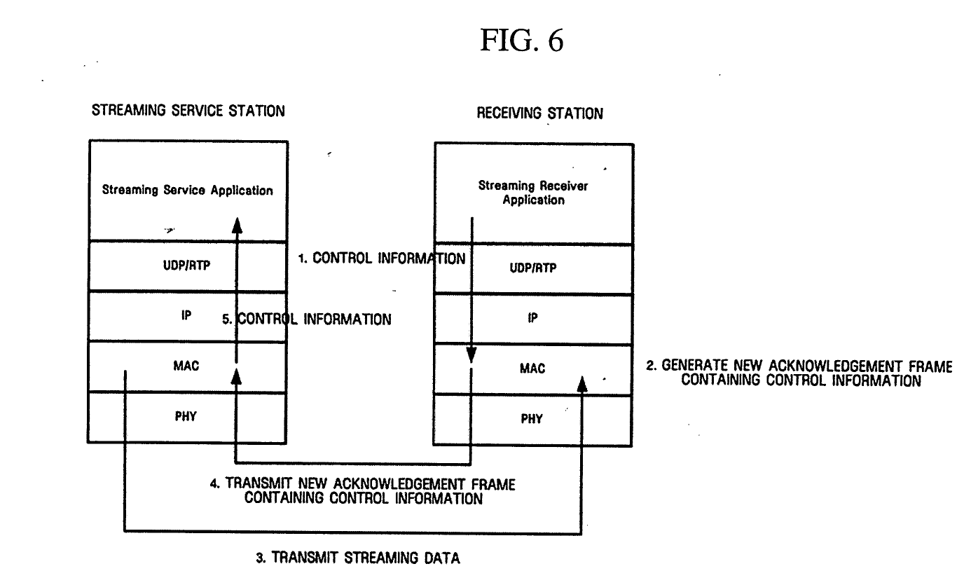

FIG. 6 illustrates transmission/reception of control information between the streaming service station and the receiving station according to an exemplary embodiment of the present invention.

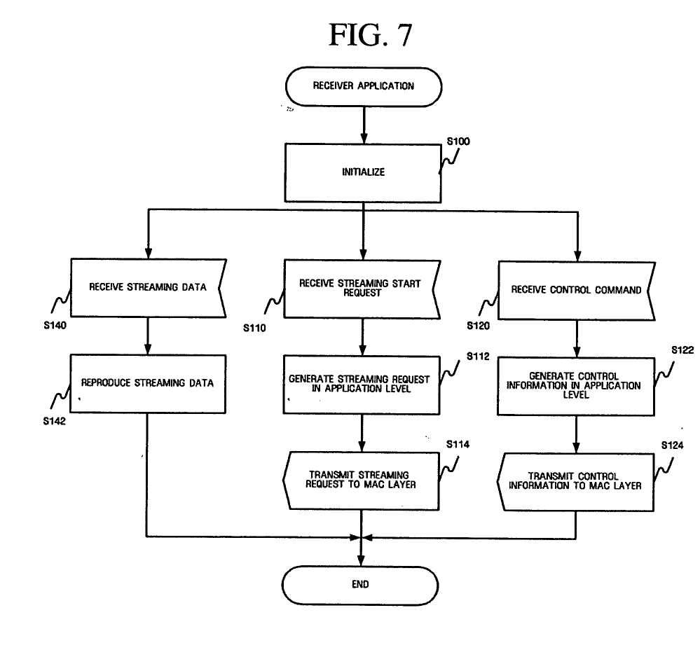

The receiving station needs to transmit various types of control information to the streaming service station while receiving the streaming data as shown in FIG. 5. For example, the control information may be a request to stop transmitting the streaming data, a request to transmit new streaming data, or a request for the streaming data having a different resolution. FIG. 6 illustrates a method of transmitting such control information to the streaming service station. The streaming receiver application transmits control information to the MAC layer of the receiving station according to a user's command. The MAC layer generates a new acknowledgement frame by embedding the control information into an old acknowledgement frame and transmits the new acknowledgement frame containing the control information to the streaming service station when acknowledging in response to reception of the streaming data. The streaming service station extracts the control information from the received new acknowledgement frame and executes the control information. The detailed operations of the streaming service station and the receiving station in the application layer and the MAC layer will be described with reference FIGS. 7 through 10 below.

FIG. 7 is a flowchart of operations of a receiving station in an application layer, in an exemplary embodiment of the present invention.

A receiver application in the receiving station is initialized in step S100. After being initialized, the receiver application is in a standby state to receive a user's command or data from a MAC layer in the receiving station. If the receiver application receives a streaming start request from the user in step S110, it generates a streaming request in step S112. The streaming request contains various types of information regarding streaming data desired to be received from a transmitting station, i.e., a streaming service station, such as a streaming data file name, resolution, and transmission start time, needed for data streaming. The streaming request is transmitted to the MAC layer in step S114. Meanwhile, if the receiver application receives streaming data from the MAC layer in step S140, it reproduces the streaming data in step S142. While reproducing the streaming data, if the receiver application receives a control command such as stop of reproducing or reproducing of another streaming data from the user in step S120, it generates control information in step S122 and transmits the control information to the MAC layer in step S124.

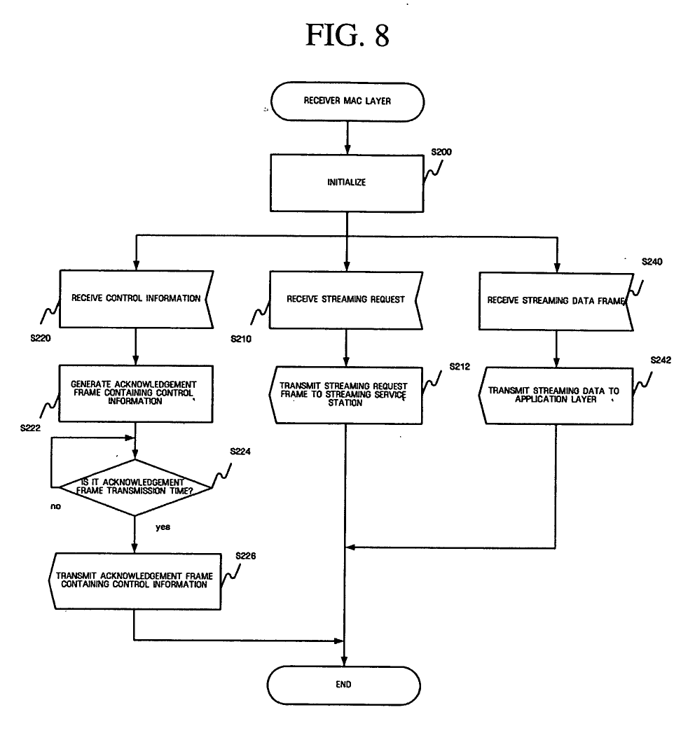

FIG. 8 is a flowchart of operations of a receiving station in a MAC layer, in an exemplary embodiment of the present invention.

A receiver MAC layer in the receiving station is initialized in step S200. Then, the receiver MAC layer is in a state where it can generate a frame by adding a header and a tail to data received from an application layer and transmit the frame to an external station or in a state where it can extract necessary data from an externally received frame and transmit the data to the application layer. If the receiver MAC layer receives a streaming request from the application layer in step S210, the receiver MAC layer generates and transmits a streaming request frame to a transmitting station, i.e., a streaming service station, in step S212. Meanwhile, if the receiver MAC layer receives control information from the application in step S220, the receiver MAC layer generates an acknowledgement frame containing the control information in step S222. Thereafter, the receiver MAC layer determines whether it is an acknowledgement frame transmission time in step S224 and transmits the acknowledgement frame containing the control information at the acknowledgement frame transmission time to the streaming service station in step S226. Meanwhile, if the receiver MAC layer receives a streaming data frame in step S240, the receiver MAC layer extracts streaming data from the streaming data frame and transmits the streaming data to the application in step S242.

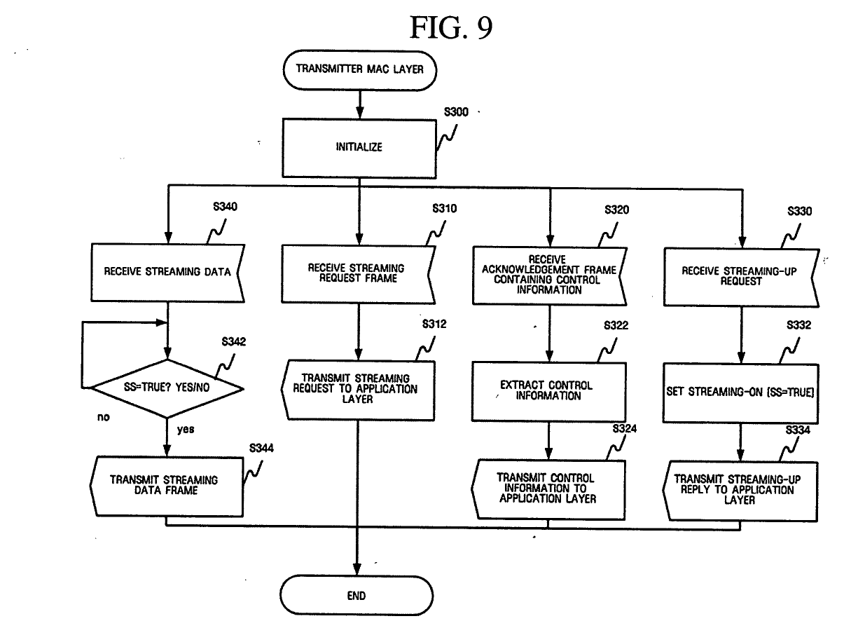

FIG. 9 is a flowchart of operations of a streaming service station in a MAC layer, in an exemplary embodiment of the present invention.

A transmitter MAC layer in the streaming service station is initialized in step S300. Then, the transmitter MAC layer is in a state where it can generate a frame by adding a header and a tail to data received from an application layer and then transmit the frame to an external station or in a state where it can extract necessary data from an externally received streaming request frame or an acknowledgement frame containing control information and then transmit the extracted data to the application layer. If the transmitter MAC layer receives a streaming request frame from outside in step S310, the transmitter MAC layer extracts and transmits a streaming request to the upper application layer in step S312. If the transmitter MAC layer receives an acknowledgement frame containing control information in step S320, it extracts the control information from the acknowledgement frame in step S322 and transmits the control information to the application layer in step S324. Meanwhile, if the transmitter MAC layer receives a streaming-up request demanding preparation for data streaming from the application layer in step S330, it sets a streaming-on state in step S332 and transmits a streaming-up replay indicating that the streaming-on has been set to the application layer in step S334. Meanwhile, if streaming data is received from the application layer in step S340, the transmitter MAC layer verifies whether the streaming-on state has been set in step S342. If the streaming-on state has been set, the transmitter MAC layer generates a streaming data frame by adding a header and a tail to the streaming data and transmits streaming data frames with the SIFS interval in step S344. Transmitting frames with SIFS interval means transmitting a frame after an SIFS from reception of acknowledgement for a previous frame.

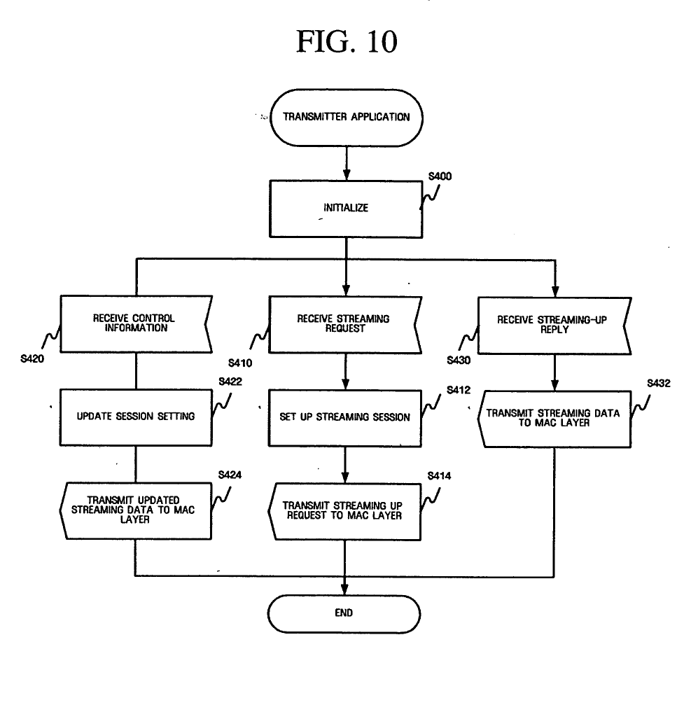

FIG. 10 is a flowchart of the operations of a transmitting station, i.e., a streaming service station, in an application layer, in an exemplary embodiment of the present invention.

A transmitter application is initialized in step S400. Thereafter, if a streaming request is received from a MAC layer in step S410, the transmitter application sets up a streaming session in step S412 and transmits a streaming-up request to the MAC layer in step S414. If a streaming-up reply indicating that streaming-up has been set is receive from the MAC layer in step S430, the transmitter application transmits streaming data to the MAC layer in step S432. Meanwhile, if control information requesting transmission of new streaming data is received from the MAC layer in step S420, the transmitter application updates a session setting in step S422 and transmits updated streaming data to the MAC layer in step S424. Although not shown in FIG. 10, if the control information requests to stop data streaming, the transmitter application stops streaming transmission to the MAC layer.

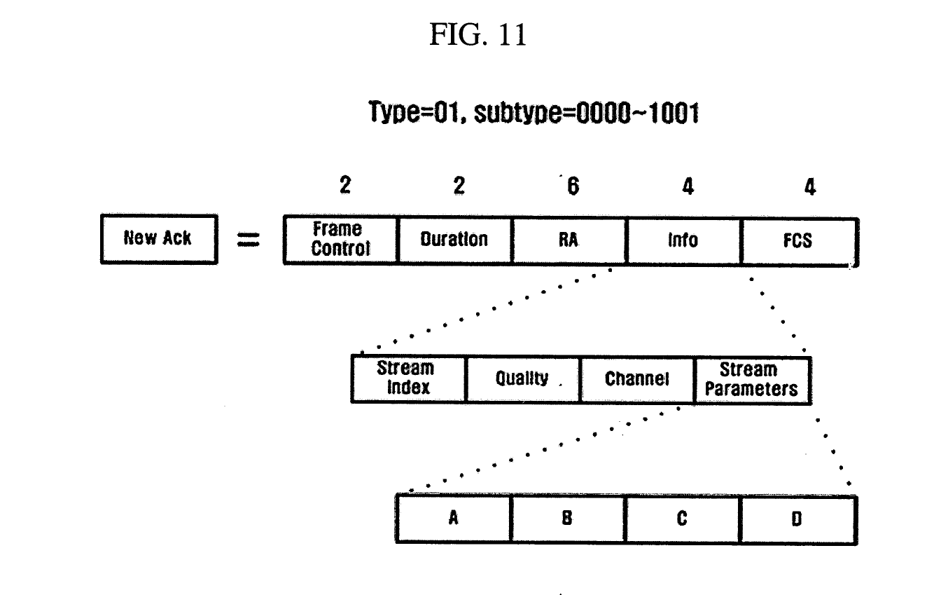

FIG. 11 illustrates an acknowledgement frame containing control information according to an exemplary embodiment of the present invention. The acknowledgement frame shown in FIG. 11 complies with the 802.11 specification.

A new acknowledgement (Ack) frame containing control information includes a 2-byte frame control field, a 2-byte duration field, a 6-byte receiver address to (RA) field, a 4-byte information (Info) field, and a 4-byte frame check sequence (FCS) field for error check. The Info field may include a stream index for identifying a stream, a quality indicating a resolution of the stream such as HD or SD, a channel to transmit the stream, and stream parameters defining the stream. The stream parameters may include information such as a 5.1 channel, a Dolby system, a wide or normal screen, and a buffering time.

In the frame control field, first two bits indicate a protocol version. Next two bits indicate a type of the frame, and other four bits indicate a subtype of the frame. Since an Ack frame is a control type, the type in the frame control field is set to 01. In addition, since the frame is a new Ack frame, the subtype in the frame control field is set to one value among 0000 through 1001 that are reserved conventionally without being used. Besides, the frame control field includes ToDS, FromDS, additional piece, retrial, power management, additional data, wired equivalent privacy (WEP), and sequence, each of which is one bit in length.

The duration field may be used to set a network allocation vector (NAV). To set the NAV, a last bit (i.e., bit number 15) of the duration field is set to 0, and a time (in microseconds) necessary for data transmission is set.

As in Ethernet, an RA in the new Ack frame is a 48-bit IEEE MAC identifier corresponding to a station that transmits the frame to an upper protocol layer for an operation of the frame.

The FCS field is used to check the integrity of a received frame and is referred to as a cyclic redundancy check (CRC) field. When a transmitting station wirelessly transmits a frame, an FCS is calculated before the frame is transmitted through radio frequency or infrared rays. A receiving station calculates an FCS from the received frame and compares the calculated FCS with the received FCS. If they are identical, the received frame is determined as being normally transmitted without an error. If the received frame is normal, the receiving station transmits an Ack frame to the transmitting station.

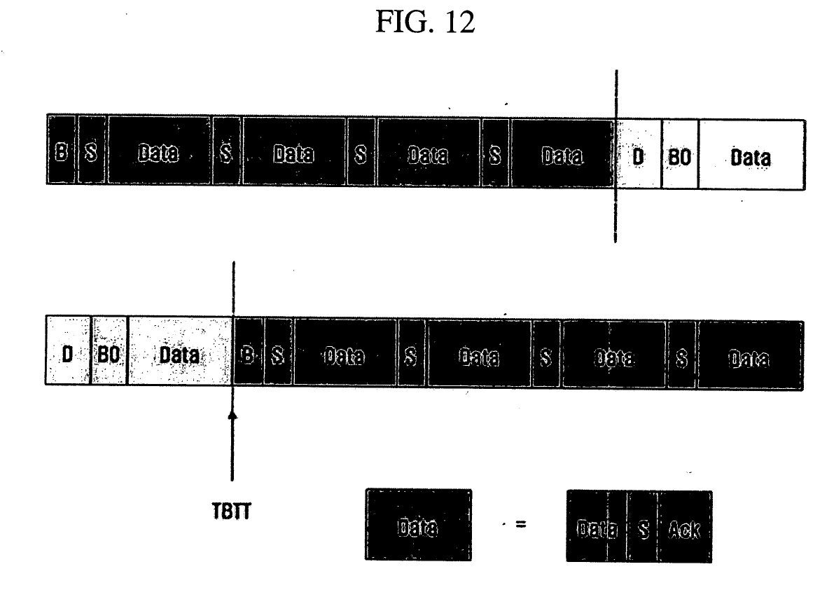

FIGS. 12 through 15 illustrate the configurations of a channel in different situations.

FIG. 12 illustrates the configuration of a channel transmitting streaming data ideally. In FIG. 12, B denotes a beacon frame, S denotes a SIFS, D denotes a DIFS, and BO denotes a backoff time. Data conceptually includes a transmitted data frame and its Ack frame received after a SIFS.

If a beacon frame is transmitted after a streaming request frame is received from a receiver, a transmitter transmits a data frame to the receiver immediately after an SIFS. In an ad-hoc wireless LAN, every station is designed to transmit data after a DIFS and a backoff time. Here, if a transmitter where streaming-up is set transmits a data frame after an SIFS, the other stations are inevitably defeated in channel competition. Thereafter, the transmitter continuously tralismits data frames with the SIFS interval. When the transmitter completes data frame transmission, the other stations competitively transmit data frames after a DIFS and a backoff time. Thereafter, if a target beacon transmission time (TBIT) is encountered, one among the stations competitively transmits a beacon frame after a random delay. If the transmitter receives the beacon frame, it transmits data frames with the SIFS interval after a SIFS.

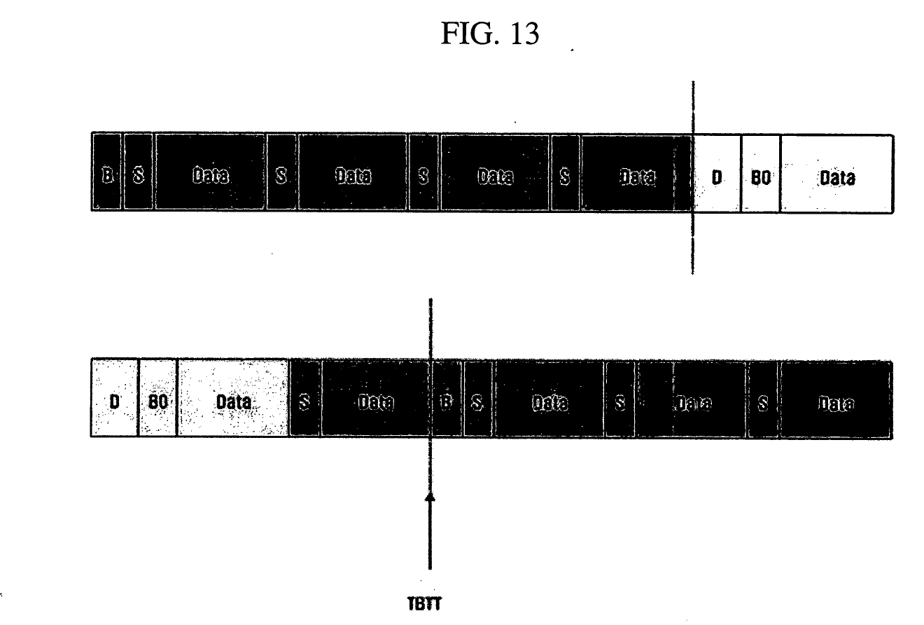

FIG. 13 illustrates the configuration of a channel where a TBTT is encountered during streaming data transmission. If a TBTT is encountered while a transmitter is transmitting streaming data frames, the transmitter ignores a random delay and preferentially transmits a beacon frame and then continuously transmits streaming data frames with a SIFS interval.

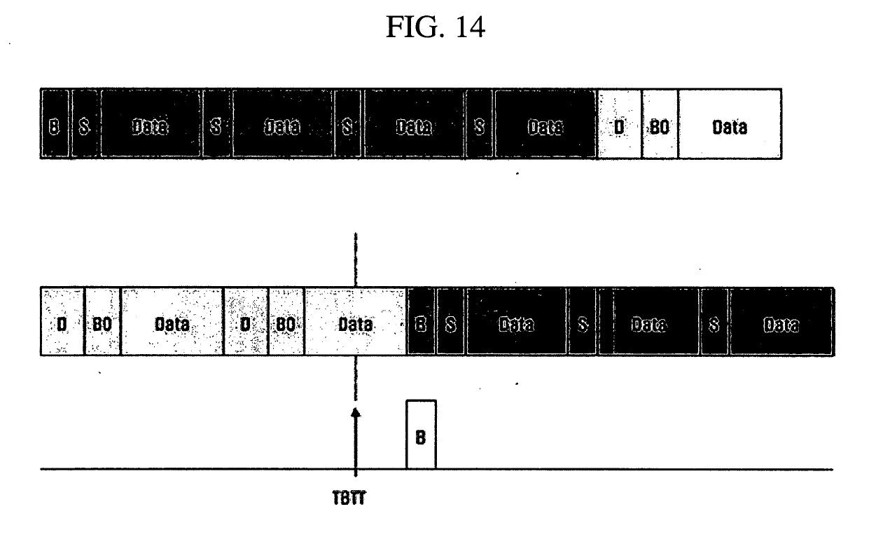

FIG. 14 illustrates the configuration of a channel where beacon collision occurs at a TBTT during normal data transmission. When beacon collision occurs at a TBTT during normal data transmission, a transmitter ignores a random delay and immediately transmits a beacon frame, and thereafter, it transmits frames with a SIFS interval.

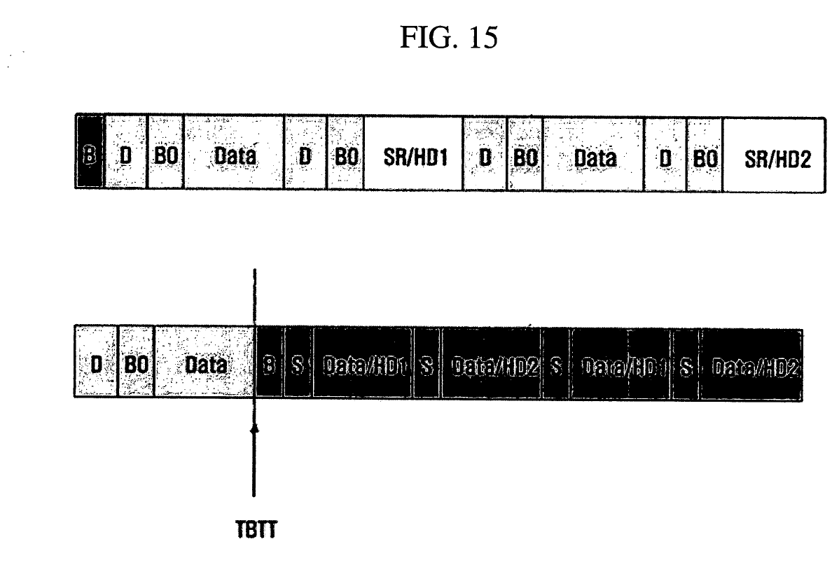

FIG. 15 illustrates the configuration of a channel where collision with a beacon transmitted by a station having a random delay of 0 occurs when a start of streaming data transmission coincides with a TBTT.

In FIG. 15, SR/HD1 and SR/HD2 denote frames requesting HD streaming, and Data/HD1 and Data/HD2 denote frames containing HD streaming data. Each of the receivers wanting streaming data waits for a DIFS and a backoff time after stations transmit frames and then competitively transmits a stream request frame. Upon receiving stream request frames, a transmitter prepares streaming data for a predetermined period of time and then transmits streaming data frames to the receivers with the SIFS interval. Meanwhile, when a TBTT incidentally encounters completion of a station's data transmission and when the transmitter transmits a beacon ignoring a random delay, the beacon may incidentally collide with a beacon transmitted by the station having a random delay of 0. In this case, a new beacon may be transmitted, but it is preferable to ignore beacon transmission and transmit streaming data frames to each receiver with the SIFS interval. This is because, in embodiments of the present invention, a beacon just serves to provide a time stamp for synchronizing stations, and even when one beacon is not received, a difference in time stamp among stations is not so large.

While the present invention has been particularly shown and described with reference to exemplary embodiments thereof, it will be understood by those skilled in the art that various changes in form and details may be made therein without departing from the spirit and scope of the invention as defined by the appended claims and without changing any of its essential features. The disclosed exemplary embodiments of the invention are used in a generic and descriptive sense only and not for purposes of limitation.

According to the present invention, streaming data is reliably transmitted in an ad-hoc wireless LAN without greatly changing conventional wireless LAN standards. In addition, the present invention allows control information to be embedded into an Ack frame and transmitted even while streaming data frames are transmitted with the SIFS interval, and therefore, a receiver can transmit control information such as a request to change or stop streaming to a transmitter even during transmission of streaming data.

1. A method for data streaming in an ad-hoc wireless local area network, the method comprising:
receiving a streaming request frame that requests transmission of first streaming data to a predetermined station; and
transmitting frames containing the first streaming data to the predetermined station with a Short InterFrame Space (SIFS) interval.

2. The method of claim 1, wherein the streaming request frame is transmitted by the predetermined station.

3. The method of claim 2, further comprising performing an operation according to predetermined control information when an acknowledgement containing the predetermined control information is received from the predetermined station.

4. The method of claim 3, wherein the predetermined control information contained in the received acknowledgement is a streaming request that requests transmission of second streaming data, and the operation, according to the predetermined control information is transmitting frames containing the second streaming data to the predetermined station with the SIFS interval.

5. A method for data streaming in an ad-hoc wireless local area network, the method comprising:
receiving a first streaming request frame that requests transmission of first streaming data to a first station;
receiving a second streaming request frame that requests transmission of second streaming data to a second station; and
transmitting frames containing the first streaming data to the first station and frames containing the second streaming data to the second station with a Short InterFrame Space (SIFS) interval, according to a predetermined sequence.

6. The method of claim 5, wherein the first streaming request frame is transmitted by the first station, and the second streaming request frame is transmitted by the second station.

7. The method of claim 6, further comprising performing an operation according to predetermined control information when an acknowledgement containing the predetermined control information is received from one of the first and second station.

8. The method of claim 7, wherein the predetermined control information, contained in the received acknowledgement, is a streaming request that requests transmission of third streaming data, and the operation, according to the predetermined control information, is transmitting frames containing the third streaming data to the transmitting station that sent an acknowledgement frame containing the control information.

9. A method for data streaming in an ad-hoc wireless local area network, the method comprising:
generating a streaming request frame requesting transmission of first streaming data and transmitting the streaming request frame to a streaming service station; and
receiving frames containing the first streaming data from the streaming service station with a Short InterFrame Space (SIFS) interval.

10. The method of claim 9, further comprising generating acknowledgements for frames containing predetermined control information contained in a received acknowledgement and receiving frames containing third streaming data at the streaming service station with Short InterFrame Space (SIFS) interval.

11. The method of claim 10, wherein the predetermined control information contained in the received acknowledgement is control information that requests transmission of second streaming data, and further comprising receiving frames transmitted with the Short InterFrame Space (SIFS) interval containing the second streaming data from the streaming service station.

12. A system for data streaming in an ad-hoc wireless local area network, the system comprising:
a streaming service station which receives at least one streaming request frame requesting transmission of at least one streaming data and transmits frames containing the requested streaming data to at least one station with a Short InterFrame Space (SIFS) interval; and
at least one station that receives frames containing at least one streaming data transmitted from the streaming service station with SIFS interval.
